(19) United States
(12) Patent Application Publication
(10) Pub. No.: US 2007/0030462 A1
(43) Pub. Date: Feb. 8, 2007

(54) Low spring constant, pneumatic suspension with vacuum chamber, air bearing, active force compensation, and sectioned vacuum chambers

(75) Inventors: Bausan Yuan, San Jose, CA (US); Martin E. Lee, San Jose, CA (US); Alton H. Phillips, East Palo Alto, CA (US); Ping-Wei Chang, San Jose, CA (US); Akimitsu Ebihara, Fukaya (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Nikon Corporation, Chiyoda-ku (JP)

(21) Appl. No.: 11/197,576

(22) Filed: Aug. 3, 2005

(51) Int. Cl. F16M 1/00; G03B 27/00

(52) U.S. Cl. 355/18; 267/136

(57) ABSTRACT

Embodiments of the present invention are directed to an apparatus for providing a low spring constant, pneumatic suspension using vacuum for the lens in a projection system. In one embodiment, a pneumatic suspension system for a load comprises a frame; and a body movably disposed in the frame and spaced from a side wall of the frame by a gap to define a chamber in the frame above the body, the body being configured to be connected to the load. The frame includes an outlet to draw a gas from the chamber to lower the pressure in the chamber with respect to an ambient pressure outside the frame. An air bearing is formed in the gap between the body and the side wall of the frame to provide non-contact between the body and the frame. The pressure in the chamber is sufficiently lower than the ambient pressure to produce a lift force to lift the body and the load connected thereto with respect to the frame.

### CROSS-REFERENCES TO RELATED APPLICATIONS

This application relates to co-pending, commonly assigned, U.S. patent application Ser. No. 11/______ (Ref. No. PA0 683), filed ______, entitled “Projection Optical Device and Exposure Apparatus,” which claims the benefit of U.S. Provisional Patent Application No. 60/614,426, filed Sep. 30, 2004, the entire disclosures of which are incorporated herein by reference.

### BACKGROUND OF THE INVENTION

The present invention relates generally to a projection optical device provided with a projection optical system which projects an image of a predetermined pattern, and to an exposure apparatus which is used to transfer a pattern of a mask onto a substrate to manufacture various devices such as a semiconductor device, a liquid crystal display, and the like.

In a lithography process, which is one process for manufacturing a semiconductor device, an exposure apparatus is used to transfer and expose a pattern formed on a reticle (or a photomask, etc.) onto a wafer (or a glass plate, etc.) coated by photoresist as a substrate. Various types of exposure apparatuses can be used, including, for example, a batch type (stationary exposure type) projection exposure apparatus such as a stepper, and a scanning type projection exposure apparatus (scanning exposure apparatus) such as a scanning stepper.

In an exposure apparatus, the rigidity of: (i) the stages which move and position a reticle and a wafer, (ii) a support mechanism of the stages, and (iii) a mechanism portion of the support mechanism and the like of a projection optical system, significantly affects the performance capability of the apparatus, such as a vibration control performance capability, an exposure accuracy (overlay accuracy or the like), weight of the mechanism portion, and manufacturing cost of the exposure apparatus. In general, an exposure apparatus having a mechanism portion with high rigidity, while providing a high apparatus performance capability, tends to have a heavy mechanism portion, and a higher manufacturing cost. Furthermore, the rigidity of the mechanism portion also is related to the temperature characteristics of the apparatus performance capability, and the stability of the apparatus performance capability corresponding to changes of the apparatus performance capability over time. That is, exposure apparatuses having a mechanism portion with a high rigidity tend to have good stability with respect to the apparatus performance capability, and excellent temperature characteristics, but depending on the structure of the mechanism portion, there are cases in which the opposite trend occurs. For example, in a mechanism portion, when members with high rigidity are coupled to each other through members having high rigidity, vibration can be easily transmitted, a bi-metal effect is generated at the time of temperature change (if different materials are used for the members), and the temperature characteristics may be deteriorated.

As a result of increasing rigidity of the mechanism portion, however, when the weight of the mechanism portion increases, there is also a possibility of increased construction cost of the device manufacturing factory in which the exposure apparatus is installed in order to deal with the weight of the exposure apparatus. Therefore, to maintain high rigidity and perform positioning and scanning at a high speed while reducing the apparatus weight, a lightweight material with high relative specific stiffness (stiffness divided by the mass per unit volume), such as a ceramic, can be used conventionally as a material of a part of the members which constitute a stage.

Furthermore, an exposure apparatus also has been proposed in which the stages and the projection optical system are independently supported by parallel link mechanism, each having a plurality of rods which can expand and contract. Such a system maintains a high rigidity in a necessary portion and lightens the weight of the entire mechanism portion (see, e.g., International Publication No. WO 01/022480).

Thus, in a conventional exposure apparatus, to maintain a high device capability with respect to vibration control performance or the like, it is desirable to improve the rigidity of a mechanism portion of a support mechanism or the like, while reducing the weight of the mechanism portion. Among conventional technology with respect to a method of using a material with a high specific stiffness and light weight, however, the material can be used only for a part of the mechanism portion due to its high manufacturing cost, the material shape, or the like, such that the lightening of the entire mechanism portion is not yet significantly improved. To further lighten the entire mechanism portion, it is desirable to change the structure itself of the mechanism portion including the support mechanism of the projection optical system.

Meanwhile, in the method that uses parallel link mechanisms, each having a plurality of elongatable rods, it is desirable to further improve the lightening of the mechanism portion, and the control accuracy of a movable portion of a stage. There is a possibility, however, that control at the time of scanning and stage positioning also becomes complex because the structure of the mechanism portion becomes complex. Additionally, although the projection optical system can be supported by using the parallel link mechanism, this tends to cause the structure of the mechanism portion to become even more complex. In this regard, in recent exposure apparatus, a thermal distortion amount of the mechanism portion and a fluctuation amount of imaging characteristics of the projection optical system due to the exposure amount of the exposure beam and the surrounding temperature are predicted in advance. According to this prediction result, correction of the imaging characteristics, positioning correction of the reticle and the wafer, or the like is performed during use of the apparatus. Once the mechanism portion becomes complex, however, the predicted accuracy of the thermal distortion amount of the mechanism portion and the fluctuation amount of the imaging characteristics deteriorates, and thus it is possible that the exposure accuracy may deteriorate.

### BRIEF SUMMARY OF THE INVENTION

Embodiments of the present invention are directed to an apparatus for providing a low spring constant, pneumatic suspension using vacuum for a projection system. The use of a vacuum chamber with either an air bearing or a low stiffness vacuum seal produces a low spring constant suspension mechanism for supporting the projection system. Sectioned vacuum chambers may be used. In some embodiments, active force compensation using one or more force compensation motors with controllers produces isolation of the suspension system from external vibrations and disturbances as well as pressure fluctuations and vacuum regulation irregularities.

In accordance with an aspect of the present invention, a pneumatic suspension system for a load comprises a frame; and a body movably disposed in the frame and spaced from a side wall of the frame by a gap to define a chamber in the frame above the body, the body being configured to be connected to the load. The frame includes an outlet to draw a gas from the chamber to lower the pressure in the chamber with respect to an ambient pressure outside the frame. An air bearing is formed in the gap between the body and the side wall of the frame to provide non-contact between the body and the frame. The pressure in the chamber is sufficiently lower than the ambient pressure to produce a lift force to lift the body and the load connected thereto with respect to the frame.

In some embodiments, the gap is about 5 microns or less and is greater than zero. The frame includes an inlet to introduce a gas into the gap between the body and the side wall of the frame to form the air bearing. The frame includes a porous portion disposed on the side wall and coupled to the inlet to distribute the gas into the gap between the body and the side wall of the frame to form the air bearing. The body is connected to an optical system of a projection exposure apparatus. The system provides three frames and three corresponding bodies movably disposed in the frames, respectively, wherein the bodies are connected to a suspension frame of the optical system at three locations which are spaced apart by about 120°. A force compensation motor is coupled between the frame and the body. The force compensation motor comprises a voice coil motor. The force compensation motor may be disposed inside the chamber of the frame. The force compensation motor may be disposed outside the chamber of the frame.

In accordance with another aspect of the invention, a pneumatic suspension system for a load comprises a frame; a body movably disposed in the frame and spaced from a side wall of the frame by a gap to define a chamber in the frame above the body, the body being configured to be connected to the load; a seal disposed in the gap and connected between the body and the side wall of the frame; and a force compensation motor coupled between the frame and the body. The frame includes an outlet to draw a gas from the chamber to lower the pressure in the chamber with respect to an ambient pressure outside the frame. The pressure in the chamber is sufficiently lower than the ambient pressure to produce a lift force to lift the body and the load connected thereto with respect to the frame.

In some embodiments, the seal comprises a soft rubber or a diaphragm. The force compensation motor is configured to produce a vertical compensation force in a direction parallel to the lift force. The force compensation motor is configured to produce a horizontal compensation force in a direction perpendicular to the lift force. The force compensation motor comprises a voice coil motor. The force compensation motor may be disposed inside the chamber of the frame. The force compensation motor may be disposed outside the chamber of the frame.

In specific embodiments, a first controller is configured to receive a pressure difference measurement between the pressure in the chamber and the ambient pressure and to provide feedback control to the force compensation motor based on the pressure difference measurement. A second controller is configured to receive a relative motion measurement between the body and the frame and to provide feedback control to the force compensation motor based on the relative motion measurement. The feedback control from the first controller is configured to compensate for pressure fluctuation and irregularity. The feedback control from the second controller is configured to compensate for external vibration and disturbance of the seal.

In accordance with another aspect of the present invention, a pneumatic suspension system for a load comprises a frame; a body movably disposed in the frame and spaced from a side wall of the frame by a gap to define an upper chamber in the frame above the body; an upper seal disposed in the gap and connected between the body and the side wall of the frame; a connecting member connected to the body and configured to be connected to the load; and a lower seal disposed below the body and connected between the connecting member and the side wall of the frame to define a lower chamber in the frame between the upper seal and the lower seal. The frame includes an upper outlet to draw a gas from the upper chamber to lower the pressure in the upper chamber with respect to an ambient pressure outside the frame. The frame includes a lower outlet to draw a gas from the lower chamber to lower the pressure in the lower chamber with respect to the ambient pressure. The pressure in the upper chamber is sufficiently lower than the pressure in the lower chamber to produce a lift force to lift the body and the load connected thereto with respect to the frame.

In some embodiments, the lower seal is made of a material which has a higher stiffness than a material of which the upper seal is made. The lower seal is made of a material which is safer to exposure to the ambient than a material of which the upper seal is made. The pressure in the lower chamber is slightly lower than the ambient pressure. The lower seal has a larger area than the upper seal. The lower seal has a substantially larger area than the upper seal. The lower seal has a corrugated construction.

### BRIEF DESCRIPTION OF THE DRAWINGS

FIG. 1 is a diagram showing a schematic structure of a projection exposure apparatus which may implement the suspension system of the present invention.

FIG. 2 is a perspective view showing a schematic structure of a mechanism portion of a projection exposure device utilizing mechanical suspension.

FIG. 2A is a plan view which cuts through a portion showing a flange and a projection optical system of FIG. 2.

FIG. 3 is simplified elevational view of a pneumatic suspension apparatus for supporting a projection optical system according to an embodiment of the present invention.

FIG. 4 is a plan view of a suspension frame for a projection optical system according to an embodiment of the present invention.

FIG. 5 is a simplified elevational view of a pneumatic suspension apparatus with active force compensation according to an embodiment of the present invention.

FIG. 6 is a simplified elevational view of a pneumatic suspension apparatus with active force compensation according to another embodiment of the present invention.

FIG. 7 is a flow diagram illustrating active force compensation of the pneumatic suspension apparatus by feedback control according to an embodiment of the present invention.

FIG. 8 is a simplified elevational view of a pneumatic suspension apparatus with sectioned vacuum chambers according to another embodiment of the present invention.

FIG. 9A is a flow diagram illustrating a fabrication process of devices using the above described systems.

FIG. 9B is a flow diagram illustrating the wafer processing step in the fabrication process of FIG. 9A.

### DETAILED DESCRIPTION OF THE INVENTION

Embodiments of the present invention are directed to an apparatus for providing a low spring constant, pneumatic suspension using vacuum for the lens in a projection system. The projection system may be a batch type projection exposure apparatus such as a stepper or the like, or a scanning type projection exposure apparatus such as a scanning stepper or the like.

Projection Exposure Apparatus

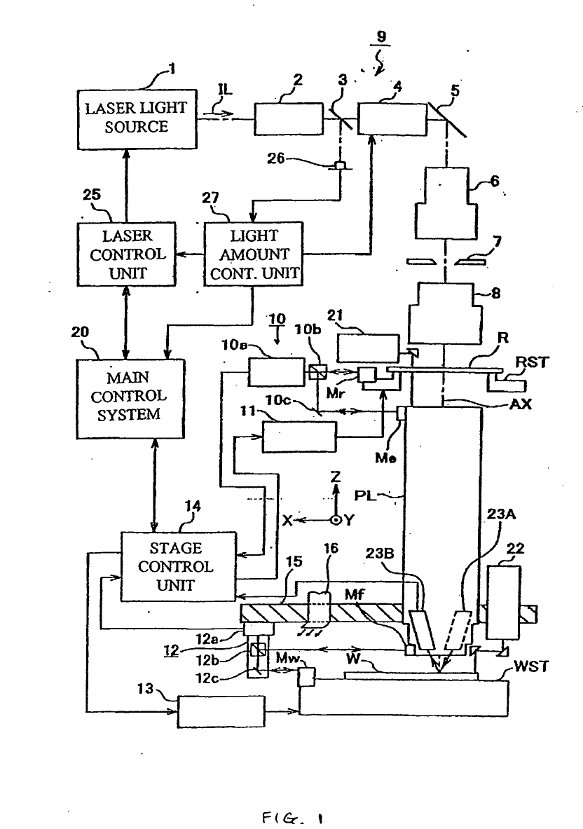

FIGS. 1-6 illustrate a projection exposure apparatus which may implement the low spring constant, pneumatic suspension mechanism of the present invention. FIG. 1 is a block diagram of different functional units which constitute the projection exposure apparatus of this embodiment. In FIG. 1, a chamber in which the projection exposure apparatus is located, is omitted. In FIG. 1, a laser light source 1 is provided. The laser light source 1 can be a KrF excimer laser (wavelength 248 nm) or an ArF excimer laser (wavelength 193 nm), for example. The light source also may be a device which radiates an oscillating laser beam in an ultraviolet range such as an F₂ laser (wavelength 157 nm), or a device which radiates a harmonic laser beam in a vacuum ultraviolet range that can be obtained by wavelength-converting a laser beam in a near infrared range supplied from a solid-state laser light source (YAG or a semiconductor laser, or the like). A mercury discharge lamp which is often used in this type of exposure apparatus can also be used.

Illumination light for exposure (exposure light) IL as an exposure beam from the laser light source 1 irradiates a reticle blind mechanism 7 with a uniform irradiation distribution via a homogenizing optical system 2, which is constituted by a lens system and a fly's eye lens system, a beam splitter 3, a variable attenuator 4 for adjusting a light amount, a mirror 5, and a relay lens system 6. The illumination light IL which was restricted to a predetermined shape (e.g., a square shape in a batch exposure type, and a slit shape in a scanning exposure type) by the reticle blind mechanism 7 is irradiated onto a reticle R (a mask) via an imaging lens system 8, and an image of an opening of the reticle blind 7 is imaged on the reticle R. An illumination optical system 9 is constituted by the above-described homogenizing optical system 2, the beam splitter 3, the variable attenuator 4, the mirror 5, the relay lens system 6, the reticle blind mechanism 7, and the imaging lens system 8.

In a circuit pattern region formed on the reticle R, the image of the portion irradiated by the illumination light is imaged and projected onto a wafer W coated by photoresist (a photosensitive substrate or a photosensitive body) via a projection optical system PL having a reduction projection magnification β and being both-side telecentric. For example, the projection magnification β of the projection optical system PL can be ¼, ⅕, or the like; the imaging side numeral aperture NA can be 0.7; and a diameter of a field of view can be approximately 27-30 mm. The projection optical system PL is a refractive system, but a cata-dioptric system or the like can also be used. The reticle R and the wafer W can be considered as first an second objects, respectively. In the following explanation, a Z axis is defined to be parallel to an optical axis AX of the projection optical system PL, an X axis extends in a direction parallel to a paper plane of FIG. 1 and is perpendicular to the Z axis, and a Y axis extends in a direction perpendicular to a paper plane of FIG. 1. When a projection exposure apparatus of this example is a scanning exposure type, a direction (Y direction) along the Y axis is a scanning direction of the reticle R and the wafer W during scanning exposure, and the illumination region on the reticle R becomes an elongated shape extending in a direction (X direction) along the X axis, which is a non-scanning direction.

Furthermore, the reticle R which is arranged on an object side of the projection optical system PL is held by vacuum to a reticle stage RST (mask stage). In the case of a batch exposure type, the reticle stage RST (micro-moving mechanism) is micro-moved on a reticle base (undepicted) in the X and Y directions and in a rotation direction about the Z axis direction so as to position the reticle R. Meanwhile, in the case of the scanning exposure apparatus, the reticle stage RST (stage) is moved at a constant speed at least in the Y direction (scanning direction) via an air bearing on a reticle base (undepicted). The moving coordinate position (the positions in the X and Y directions, and the rotation angle about the Z axis) of the reticle stage RST is successively measured by a moving mirror Mr fixed to the reticle stage RST, a reference mirror Me fixed to the upper portion side surface of the projection optical system PL, and a laser interferometer system 10 arranged opposite to these mirrors. The laser interferometer system 10 includes a laser interferometer main body portion 10a, a beam splitter 10b which divides the laser beam into a beam for the moving mirror Mr and a beam for the reference mirror Me, and a mirror 10c which supplies the laser beam to the reference mirror Me. In addition, the moving mirror Mr, the reference mirror Me, and the laser interferometer system 10 constitute at least a uniaxial laser interferometer system in the X direction, and a biaxial or a triaxial laser interferometer system in the Y direction.

The movement of the reticle stage RST is performed by a driving system 11 comprised of a linear motor and a micro-moving actuator, or the like. The measurement information of the laser interferometer system 10 is supplied to a stage control unit 14, and the stage control unit 14 controls the operation of the driving system 11 based on the control information (input information) received from a main control system 20 comprised of a computer which controls the operation of the entire device, and the measurement information.

Meanwhile, the wafer W arranged on the image side of the projection optical system PL is vacuumed and held on the wafer stage WST (substrate stage) via an undepicted wafer holder. In the case of the batch type, the wafer stage WST is step-moved in the X and Y directions via an air bearing on a wafer base (undepicted). In the case of the scanning type, the wafer stage WST can be moved at a constant speed at least in the Y direction at the time of scanning exposure, and is mounted on a wafer base (undepicted) via an air bearing so as to be step-moved in the X and Y directions. The moving coordinate position (the positions in the X and Y directions, the rotation angle about the Z axis) of the wafer stage WST is successively measured by a reference mirror Mf fixed to the lower portion of the projection optical system PL, a moving mirror Mw fixed to the wafer stage WST, and a laser interferometer system 12 arranged opposite to these mirrors. The laser interferometer system 12 includes a laser interferometer main body portion 12a, a beam splitter 12b which divides a laser beam into a beam for the moving mirror Mw and a beam for the reference mirror Mf, and a mirror 12c which supplies a laser beam to the moving mirror Mw. The moving mirror Mw, the reference mirror Mf, and the laser interferometer system 12 constitute at least a uniaxial laser interferometer system in the X direction, and a biaxial or a triaxial laser interferometer system in the Y direction. The laser interferometer system 12 is further provided with a biaxial laser interferometer for rotation angle measurement about the X and Y axes.

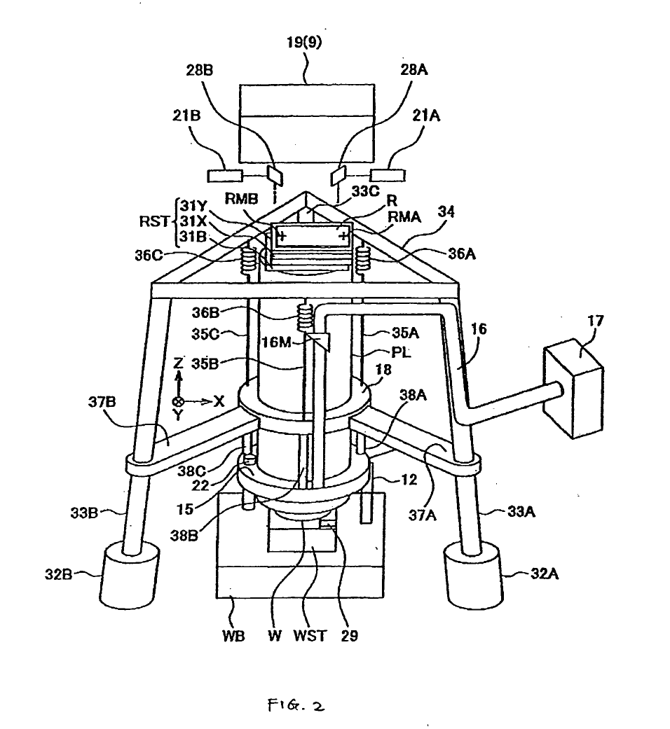

The laser interferometer system 12 (laser interferometer) can be considered as one sensor for measuring a positional relationship between the projection optical system PL and the wafer stage WST as a predetermined member. The laser interferometer system 12 is fixed to the bottom surface of a measurement mount 15 (measuring unit) which is an annular flat plate-shaped member arranged on the lower portion side surface of the projection optical system PL. In order to reduce fluctuation (fluctuation in an index of refraction) of air on the optical path of the laser beam to be supplied to the moving mirror Mw and the reference mirror Mf from the laser interferometer system 12, an air duct 16 having flexibility is fixed to the measurement mount 15. As shown in FIG. 2, the air duct 16 extends substantially parallel to a column 33A, one side of an upper column 34, and a wire 35B. Gas such as highly clean air at a controlled temperature and humidity is supplied from a small air conditioning device 17 (see FIG. 2), and the gas is supplied to the optical path of the laser beam of the laser interferometer system 12 by a local downflow method. In order to couple a portion of the air duct 16 with the wire 35B, a fixed mount 16M (support member) is arranged in the vicinity of a movable portion of the wire 35B. A local gas flow mechanism is constituted which includes the small air conditioning device 17 and the air duct 16. By so doing, the measurement accuracy of the laser interferometer system 12 is improved. Additionally, a plurality of air ducts 16 can be provided.

In FIG. 1, the movement of the wafer stage WST is performed by a driving system 13 comprised of an actuator such as a linear motor, a voice coil motor (VCM), or the like. The measurement information of the laser interferometer system 12 is supplied to the stage control unit 14, and the stage control unit 14 controls the operation of the driving system 13 based on the measurement information and the control information (input information) received from the main control system 20.

The wafer stage WST is moved to control its position (focus position) in the Z direction of the wafer, by a Z-leveling mechanism which also controls an inclination angle about the X and Y axes. An oblique incident type multi-point autofocus sensor (23A, 23B) is fixed to the measurement mount 15 of the lower side surface of the projection optical system PL. The oblique incident type multi-point autofocus sensor (23A, 23B) is comprised of a projection optical system 23A which projects a slit image onto a plurality of measurement points on the surface of the wafer W, and a light receiving optical system 23B which detects the information relating to the horizontal shift amount of the image in which these slit images were re-imaged by receiving the reflected light from the surface, and supplies this information to the stage control unit 14. The stage control unit 14 calculates a defocus amount from the image plane of the projection optical system PL in the plurality of measurement points by using the information of the horizontal shift amount of the slit image, and drives the Z-leveling mechanism within the wafer stage WST by the autofocus method so that the focus amount is maintained within predetermined control accuracy at the time of exposure. A detailed structure of one type of an oblique incident type multi-point autofocus sensor is disclosed in, for example, Japanese Laid-Open Patent Application 1-253603. The entire disclosure of Japanese Laid-Open Patent Application 1-253603 is incorporated herein by reference.

The stage control unit 14 includes a control circuit on the reticle side which optimally controls the driving system 11 based on the measurement information received from the laser interferometer system 10, and a control circuit on the wafer side which optimally controls the driving system 13 based on the measurement information received from the laser interferometer system 12. If the projection exposure apparatus of this example is a scanning exposure type, when the reticle R and the wafer W are synchronously scanned at the time of scanning exposure, both control circuits coordinate and control the respective driving systems 11 and 13. The main control system 20 mutually communicates with the respective control circuits within the stage control unit 14 with respect to parameters and commands, and the respective control circuits within the stage control unit 14, and optimally performs exposure processing in accordance with a program designated by an operator. Because of this, an undepicted operation panel unit (including an input device and a display device) is provided, and forms an interface between the operator and the main control system 20.

At the time of exposure, it is desirable to align the reticle R and the wafer W in advance. Therefore, in the projection exposure apparatus of FIG. 1, a reticle alignment system (RA system) 21 which sets the reticle R at a predetermined position, and an off-axis type alignment system 22 which detects a mark on the wafer W are provided. The alignment system 22 (mark detection system) is fixed to the measurement mount 15. The multi-point autofocus sensors (23A, 23B) and the alignment system 22 can be considered as one sensor which measure the positional relationship between the projection optical system PL and the wafer stage WST or the wafer W (predetermined member).

When the laser light source 1 is an excimer laser light source, a laser control unit 25 which is controlled by the main control system 20 is provided. The laser control unit 25 controls modes (one pulse mode, burst mode, waiting mode, or the like) of pulse oscillation of the laser light source 1, and controls a discharging high voltage of the laser light source 1 in order to adjust an average light amount of the pulse laser light to be radiated. A light amount control unit 27 controls a variable attenuator 4 in order to obtain an appropriate exposure amount based on the signal received from a photoelectric detector 26 (integrator sensor) which receives part of the illumination light divided by the beam splitter 3, and sends intensity (light amount) information of the pulse illumination light to the laser control unit 25 and the main control system 20.

In the case of a batch type apparatus, an operation which, in the presence of the illumination light IL, projects a pattern of the reticle R onto one shot region on the wafer W via the projection optical system PL, and an operation which step-moves the wafer W via the wafer stage WST in the X and Y directions, are repeated by a step-and-repeat method. In the case of a scanning type apparatus, according to the scanning exposure operation, a pattern image of the reticle R is transferred to the shot region, in a state in which irradiation of the illumination light IL to the reticle R begins, the image which passed through part of the pattern of the reticle R and the projection optical system PL is projected onto one shot region on the wafer W, and, using projection magnification β of the projection optical system PL as a speed ratio, the reticle stage RST and the wafer stage WST are synchronously moved (synchronized scanning) in the Y direction. Then, by repeating the operation in which irradiation of the illumination light IL is stopped and the wafer W is step-moved in the X and Y directions via the wafer stage WST and the above-mentioned scanning exposure operation, the pattern image of the reticle R is transferred onto all of the shot regions on the wafer W by a step-and-scan method.

The following describes the details of a structure of the mechanism portion of the projection exposure apparatus of this example of the invention. This mechanism portion can be considered a projection optical device provided with a projection optical system PL. The projection exposure apparatus of this example is a batch type apparatus.

FIG. 2 shows a schematic structure of the mechanism portion of the projection exposure apparatus of this example. In FIG. 2, short cylindrical seats 32A, 32B (the third seat, 32C, is undepicted) are arranged at three locations disposed at the vertices of a triangle on the floor surface. Long columns 33A, 33B, 33C are disposed on the respective three seats 32A, 32B, 32C. The columns are arranged in a state so that position shifting is not generated, and thus thin, long cylindrical columns 33A, 33B, 33C slant inwardly to some degree as seen in FIG. 2 (rather than being perfectly vertical). The three columns 33A-33C are arranged so that the spacing between their upper portions is narrower than the spacing between the lower ends, and a substantially triangular frame-shaped upper column 34 is fixed on the top surfaces of the columns 33A-33C. A column structural body comprised of the columns 33A-33C and the upper column 34 corresponds to a frame which suspends the projection optical system PL.

The projection optical system PL is arranged within a space surrounded by the columns 33A-33C, and the flange 18 (support member) is integrally fixed to the projection optical system PL so as to substantially surround the side surface of the center in the Z direction of the projection optical system PL. The flange 18 can be integrated with a lens barrel of the projection optical system PL. One end of each of a plurality of coil springs 36A, 36B, 36C (vibration control portions), which are identical to each other, is fixed to the respective center portion of each of the three pieces of the upper column 34. The flange 18 is coupled to the other end of the coil springs 36A, 36B, 36C via wires 35A, 35B, 35C, which are identical to each and other and formed of a metal material. The wire 35A and the coil spring 36A correspond to one coupling member. In the same manner, the other wires 35B, 35C and coil springs 36B, 36C correspond to two other coupling members. These coupling members are substantially parallel to each other and parallel to the Z axis. In this example, the direction (-Z direction) toward the floor surface is a vertical direction, and a plane (XY plane) perpendicular to the Z axis is a substantially horizontal plane. Therefore, from the upper column 34, the projection optical system PL and the flange 18 are suspended and supported via the three coupling members.

In this case, the optical axis of the projection optical system PL is parallel to the Z axis, and the characteristic frequency of the coupling members of this example is lower in the direction perpendicular to the optical axis than in the direction parallel to the optical axis of the projection optical system PL. The coupling members vibrate like a pendulum in a direction perpendicular to the optical axis. Thus, if the length in the Z direction of the coupling member is L and the acceleration constant is G (9.8 m/s²), as shown in below, the longer the length L becomes, the smaller the value of the characteristic frequency fg in the direction perpendicular to the optical axis becomes.
fg=(½π)√(G/L) (1)

The smaller the characteristic frequency fg becomes, the better the vibration control performance capability (capability which prevents vibration of the floor from being transmitted to the projection optical system PL) in the direction perpendicular to the optical axis of the projection optical system PL becomes. Thus, in order to improve the vibration control performance capability, it is better to have a longer length L of the coupling members. On the other hand, in order to stably support the projection optical system PL, it is preferable that the flange 18 which is suspended by the coupling members be fixed in the vicinity of a center of gravity in the Z direction of the projection optical system PL. Moreover, in order to optimally reduce the size of the projection exposure apparatus, it is preferable that the height of the upper column 34 be not higher than the upper end portion of the projection optical system PL. From this perspective, the length L of the coupling members becomes approximately ½ or less of the Z direction length of the projection optical system PL.

As an example, the length L of the coupling members is set to be about 0.5 m. If this value is applied to Equation (1) above, the characteristic frequency fg becomes a small value, i.e., 0.7 Hz. If the length L of the coupling members is set to be 1 m or greater, according to Equation (1), the characteristic frequency fg becomes approximately 0.5 Hz or smaller, which is sufficiently small for the projection exposure apparatus.
fg≦0.5 Hz (2)
Therefore, for example, if it is possible in view of the length of the projection optical system PL, it is preferable that the length of the coupling members be set approximately between 1 and several meters.

The characteristic frequency in the optical axis direction of the projection optical system PL of the wires 35A-35C within the coupling members becomes much higher than the characteristic frequency fg. However, for example, among the vibrations transmitted to the upper column 34 via the columns 33A-33C from the floor, most of the vibration components in the optical axis direction are absorbed by the coil springs 36A-36C (vibration control portions), so that a high vibration control performance capability can be obtained in a direction parallel to the optical axis. Moreover, between the columns 33A-33C and the upper column 34, it is possible to arrange a vibration control member such as a coil spring or an air damper. In such a case, the coil springs 36A-36C in the coupling members can be omitted.

In this example, the reticle stage RST (here, micro-moving mechanism) is integrally fixed to the upper portion of the projection optical system PL. The reticle R (member in which a pattern is formed) is held by the reticle stage RST. The reticle stage RST is provided with a base portion 31B fixed to the projection optical system PL, an X stage 31X which can be micro-moved in the X direction with respect to the base portion 31B, and a Y stage 31Y which can be micro-moved in the Y direction with respect to the X stage 31X and that holds the reticle R. On the pattern formation surface of the reticle R of this example, a pair of alignment marks RMA and RMB are formed at a predetermined interval in the X direction. Reticle alignment systems (RA system) 21A, 21B are arranged above the alignment marks RMA, RMB via the perspective mirrors 28A, 28B. The pair of RA systems 21A, 21B corresponds to the RA system 21 of FIG. 1.

The projection apparatus of this example is a batch exposure type. Before exposure, after positioning of the alignment marks RMA and RMB of the reticle R by using the RA system 21A, 21B, it is not necessary to move the reticle R. Accordingly, the laser interferometer system 10 in the reticle side of FIG. 1 might be omitted in the projection exposure apparatus of FIG. 2.

The mirrors 28A, 28B and the RA systems 21A, 21B are fixed to an undepicted column coupled with the upper column 34, and an illumination system sub-chamber 19 which stores the illumination optical system 9 of FIG. 1 is fixed with respect to the column. In this case, the laser light source 1 of FIG. 1 is arranged on the floor outside the columns 33A-33C of FIG. 2 as an example, and the illumination light IL to be emitted from the laser light source is guided to the illumination optical system 9 via an undepicted beam transmitting system.

A wafer base WB is arranged via a vibration control table (undepicted) on the floor surface below the projection optical system PL, and the wafer stage WST which holds the wafer W on the wafer base WB is movably arranged thereon via an air bearing. On top of the wafer stage WST, a reference mark member 29 is fixed in which a reference mark is formed to perform alignment of the reticle R and the wafer W.

The projection optical system PL having a rigid structure of this example is suspended and supported via the coil springs 36A-36C and the wires 35A-35C, which function as coupling members having a flexible structure, with respect to the upper column 34, which has a rigid structure. In this arrangement, a high vibration control performance capability can be obtained, and the mechanism portion can be significantly lightened. However, there is a possibility that the relative position of the projection optical system PL and the upper column 34 can change at a relatively low frequency of vibration. Therefore, to maintain the relative position of the projection optical system PL and the upper column 34 (and the columns 33A-33C) in a predetermined state, a positioning device of a non-contact type is provided.

FIG. 2A is a plan view of the projection optical system PL and the flange 18 of FIG. 2. In FIG. 2A, arm portions 37A, 37B, 37C, which extend toward the flange 18, are fixed to the columns 33A, 33B, 33C. The arm portions 37A-37C are arranged at a substantially 120° intervals about the optical axis AX of the projection optical system PL. Furthermore, between the first arm portions 37A and the flange 18, a first actuator 40A which displaces the flange 18 in the Z direction and a second actuator 41A which displaces the flange 18 in a circumferential direction are provided. Voice coil motors can be used for the actuators 40A, 41A. In addition, a non-contact electromagnetic actuator, e.g., an EI core type or the like, also can be used as actuators 40A and 41A.

Additionally, on the flange 18 in the vicinity of the arm portions 37A, a first biaxial acceleration sensor 39A is provided, which detects acceleration in the Z direction and in the circumferential direction of the flange 18. The biaxial acceleration information detected by the acceleration sensor 39A is supplied to a controller 42, and the controller 42 drives the actuators 40A, 41A so that the flange 18 can be maintained stationary with respect to the arm portion 37A (and thus the upper column 34 of FIG. 2) or the earth based on the acceleration information.

In FIG. 2A, between the second arm portion 37B and the flange 18, and between the third arm portion 37C and the flange 18 as well, third and fifth actuators 40B and 40C are provided which displace the flange 18 in the Z direction, and fourth and sixth actuators 41B and 41C are provided which displace the flange 18 in the circumferential direction. The structures of the actuators 40B, 41B and 40C, 41C are the same as the actuators 40A, 41A. Furthermore, on the flange 18 in the vicinity of the arm portions 37B and 37C, the second and third biaxial acceleration sensors 39B and 39C are provided, which detect the acceleration in the Z direction and in the circumferential direction of the flange 18. The acceleration information of the acceleration sensors 39B and 39C also is supplied to the controller 42, and the controller 42 drives the actuators 40B, 41B and 40C, 41C so that the flange 18 can be maintained relatively stationary with respect to the respective arm portions 37B and 37C (and thus the upper column 34 of FIG. 2) or the earth based on the acceleration information.

As acceleration sensors 39A-39C, displacement sensors, a piezoelectric type acceleration sensor which detects a voltage generated by a piezoelectric element or the like, a semiconductor type acceleration sensor which monitors changes of a logical threshold value voltage of a CMOS converter, e.g., according to the displacement and distortion of the mass, or the like can be used. In addition to (or instead of) using the acceleration sensors 39A-39C, a position sensor is used, which directly measures the relative position between the flange 18 and the arm portions 37A-37C (and thus the upper column 34). A position sensor, for example, an eddy current displacement sensor, a capacitance type displacement sensor, and optical type sensor, or the like can be used.

Thus, the positioning device of the projection optical system PL and the flange 18 is constituted by the six-axis acceleration sensors 39A-39C (displacement sensors), the six-axis actuators 40A-40C, 41A-41C, the six position sensors and the controller 42. By this positioning device, the relative position, in the X, Y and Z directions, of the projection optical system PL with respect to the upper column 34, and the relative rotation angles about the X, Y and Z axes are maintained in a constant state (predetermined state). The response frequency of the actuators 40A-40C, 41A-41C is approximately 10 Hz, and thus with respect to vibrations up to the response frequency, the projection optical system PL of this example is supported by an active suspension method. Furthermore, with respect to vibrations of a frequency which exceeds this, the projection optical system PL is suspended and supported by a passive vibration isolation structure.

In FIG. 2A, the three columns 33A-33C are used. However, four or more columns also can be used in a different embodiment.

In FIG. 2, the bottom surface of the flange 18 (support member) of the projection optical system PL, an annular flat-shaped measurement mount 15 (measurement unit) is coupled via the three cylindrical rods 38A, 38B, 38C (link members), which extend substantially parallel to the Z axis. The measurement mount 15 is stably coupled to the flange 18 by a kinematic support mechanism comprised of a three-point support. The measurement mount 15 is fixed to the alignment system 22, the air duct 16, and the laser interferometer system 12.

In the projection exposure apparatus of FIG. 2 of this example, the projection optical system PL and the flange 18 of a rigid structure are suspended and supported by an active suspension method via the coil springs 36A-36C and the wires 35A-35C, as coupling members having a flexible structure, with respect to the upper column 34, which has a rigid structure.

Low Spring Constant, Pneumatic Suspension with Vacuum Chamber

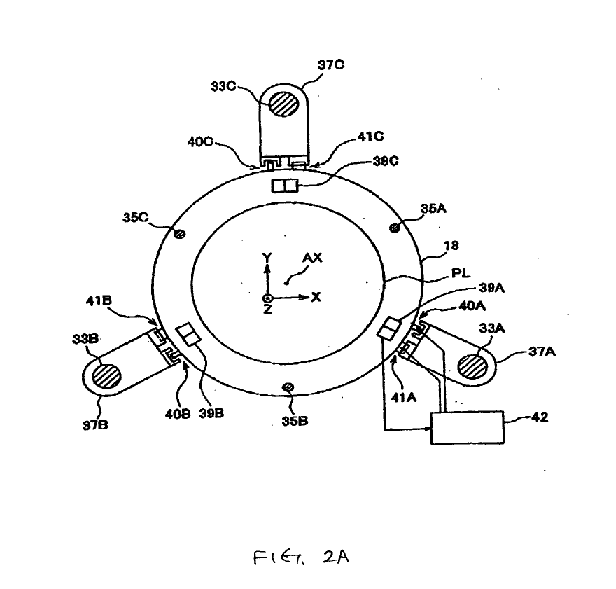

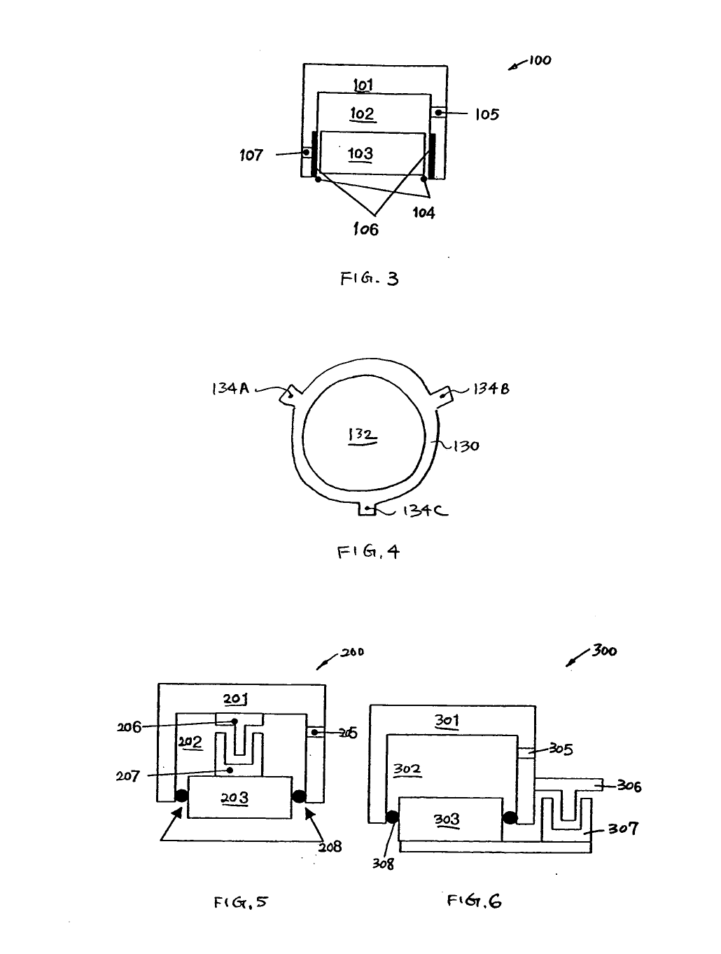

FIG. 3 shows an embodiment of a low spring constant, pneumatic suspension apparatus 100, which using a vacuum chamber to lift the projection optical system PL instead of the columns 33A-33C and the arm portions 37A-37C connected between the columns 33A-33C and the flange 18 of FIG. 2.

As shown in FIG. 3, a frame 101 defines a chamber 102 in which a piston or body 103 is movably disposed. The body 103 is spaced from the side wall of the frame 101 by a small gap 104. An air outlet 105 is provided through the frame 101, and is connected to a vacuum pump to pump air out of the chamber 102 to produce a vacuum in the chamber 102. The gap 104 is typically about 5 microns or less, and has a surface that is precision made to serve as an air flow restrictor. Due to this flow restriction, the vacuum pump can pump out quickly through the outlet 105 any air that manages to flow into the chamber 102, thus maintaining the vacuum in the chamber 102. The amount of time the air mass manages to stay in the chamber 102 before being pumped out through the outlet 105 determines the final steady vacuum level in the chamber 102.

The frame 101 provides an air bearing surface along the gap 104 for guiding the motion of the body 103. In one example, a porous material 106 is provided along the side wall of the frame 101 to serve as the air bearing surface for the gap 104. Additional air flow can be supplied to the air bearing surface by using a valve and delivering the air or gas through an inlet 107 to the porous material 106 and then through the gap 104 being finally being pumped out of the chamber 102 through the outlet 105. The amount of air supplied through the inlet 107 may be adjusted or selected. By adding more air through the inlet 107, the longer the air will stay in the chamber 102 thereby lowering the steady vacuum level therein; by reducing the amount of air through the inlet 107, the less time the air will stay in the chamber 102 thereby raising the steady vacuum level therein.

The pneumatic suspension apparatus 100 of FIG. 3 provides a steady and controllable vacuum level in the chamber 102, resulting in a clean and very low pressure level on the top side of the body 103. The bottom side of the body 103 is exposed to the ambient pressure (atmospheric air). The net pressure difference between the top side and bottom side of the body 103 results in a low stiffness, upward lift force acting on the body 103 against gravity. The side wall of the body 103 is enshrouded by air flow and hence does not make any physical contact with the frame 101. The body 103 is mechanically connected to a weight load, which in the present example is the projection optical system PL. The frame 101 is part of a machine frame structure, which is normally an extension of the ground support.

In the embodiment of FIG. 3, the environment vibration in the Z direction at the frame 101 will not be transmitted to the body 103 because there is no mechanism contact between the body 103 and the frame 101. Excellent vibration isolation at the body 103 is achieved because the body 103 is supported only by the low noise and steady lift force created by the vacuum in the chamber 102. The stiffness or spring constant of the suspension apparatus 100 of FIG. 3 is extremely low. The overall stiffness of the suspension apparatus 100 is a combination of the stiffness of the vacuum chamber 102 and of the air bearing at the gap 104. The vacuum chamber 102 has very few or virtually no air molecules, and hence little or no contribution to the overall stiffness. The air bearing at the gap 104 produces an extremely low stiffness. Therefore, the overall air mount stiffness of the pneumatic suspension apparatus 100 of FIG. 3 is very low in the Z direction.

The use of the air bearing surface 106 and the gap 104 to create restricted air flow between the body 103 and the frame 101 eliminates the need for a seal to contain the vacuum in the chamber 102. Otherwise, a vacuum seal between the body 103 and the frame 101 would introduce vibration transmission. The vacuum pump can be controlled to adjust or fine tune the vacuum level in the chamber 102 to adjust the lift force applied to the body and hence the optical system PL.

FIG. 4 shows a plan view of a suspension frame 130 for an optical system 132, which is similar to the flange 18 for the projection optical system PL of FIG. 2. Three pneumatic suspension apparatuses 100 are mechanically connected to three locations 134A, 134B, 134C of the suspension frame 130 disposed about 120° apart, forming a stable kinematic support. The weight of the optical system 132 will be divided among the three suspension apparatuses 100 to carry the load. As discussed above, the stiffness of spring constant of the pneumatic suspension apparatuses 100 is very low in the Z direction. Because the air space in the chamber 102 is essentially a vacuum, all the lifting force comes from the outside pressure and the spring constant is essentially zero. This is because the air space (chamber) 102 has no air therein to change the force on the piston or body 103 as it moves. The outside air pressure does not change with motion of the body 103.

Active Force Compensation for Pneumatic Suspension with Vacuum Chamber

FIG. 5 is a simplified elevational view of a pneumatic suspension apparatus 200 with active force compensation. A frame 201 defines a chamber 202 in which a piston or body 203 is movably disposed. An air outlet 205 is provided through the frame 201, and is connected to a vacuum pump to pump air out of the chamber 202 to produce a vacuum in the chamber 202. The body 203 is spaced from the side wall of the frame 201 by a small gap. A vacuum seal 208 is provided in the gap between the body 203 and the side wall of the frame 201. The vacuum seal 208 may include a soft rubber or a diaphragm, or may be replaced by the air bearing with air bearing surface 106 and gas inlet 107 shown in FIG. 3.

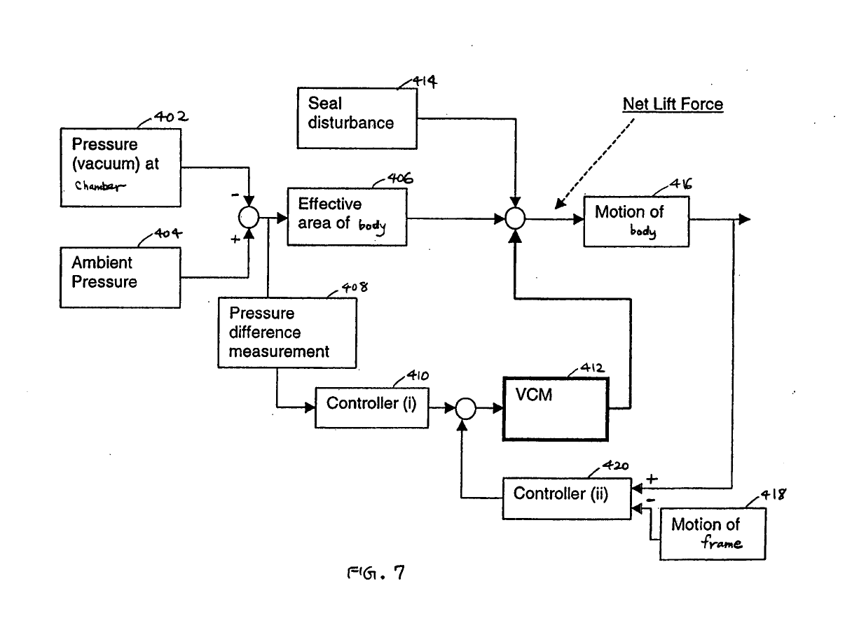

As in the embodiment of FIG. 3, the net pressure difference between the top side and bottom side of the body 203 results in a low stiffness lift force acting on the body 203 against gravity in FIG. 5. The body 203 is mechanically connected to a weight load, which in the present example is the projection optical system PL. The steadiness of the lift force applied to the body 203 can be disturbed by ambient pressure fluctuations, vacuum regulation irregularities, and vibrations passed through the seal 208, or the like. This embodiment employs a voice coil motor (voice coil 206 and magnet 207) to provide active compensation force to counter or cancel the disturbance force. The voice coil motor 206, 207 is coupled between the frame 201 and the body 203, and is disposed inside the chamber 202 in FIG. 5. In the pneumatic suspension apparatus 300 of FIG. 6, which also includes a frame 301, a chamber 302, a body 303, an outlet 305, and a vacuum seal 308, the voice coil motor 306, 307 is coupled between the frame 301 and the body 303, and is disposed outside the chamber 302.

Referring to the plan view of FIG. 4, the three locations 134A, 134B, 134C of the suspension frame 130 for the optical system 132 may be connected to three pneumatic suspension apparatuses 200 of FIG. 5 with voice coil motors that provide force compensation in the vertical direction (Z direction). Because the optical system 132 has six degrees of freedom, it may be desirable to provide three additional voice coil motors in the three pneumatic suspension apparatuses 200 oriented horizontally to provide force compensation in the horizontal direction (on the XY plane). The additional voice coil motors are connected between the frame 201 and the body 203, and may be disposed inside the vacuum chamber 202 (as in FIG. 5) or outside the vacuum chamber 302 (as in FIG. 6).

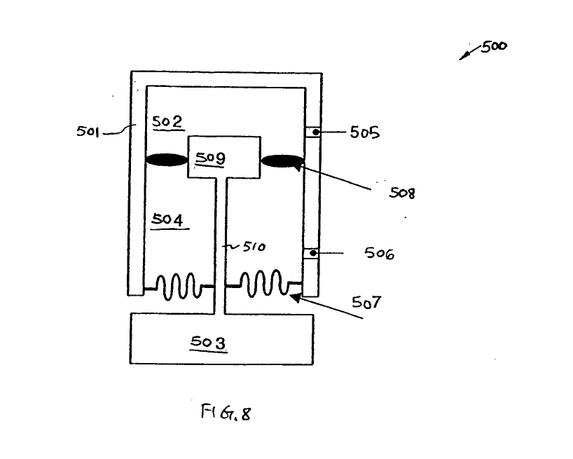

FIG. 7 is a flow diagram illustrating active force compensation of the pneumatic suspension apparatus by feedback control. The compensation action can be automated by feedback of the measurement of the pressure difference between the chamber 202 and the ambient pressure to an electronic or computer controller, which commands the voice coil motor 206, 207 to generate the compensation force to be applied to the body 203. Likewise, by measuring the motion of the body 203 and/or the relative motion between the frame 201 and the body 203, the information can be fed back to a controller to command the voice coil motor 206, 207 to generate the compensation force.

As seen in FIG. 7, a difference between the vacuum pressure in the chamber 202 (block 402) and the ambient pressure (block 404) is taken to produce a net pressure differential, which produces a lift force when multiplied by the effective area of the body 203 (block 406). The pressure difference measurement (block 408) is fed back to the first controller or pressure difference controller (block 410) which provides a first control signal to control the VCM 206, 207 (block 412) to produce a compensation force (a second control signal to control the VCM is discussed below). The lift force from block 406 is combined with the compensation force from block 412 and the seal disturbance force from block 414 to generate a net lift force to be applied to the body 203 to generate the motion for the body 203 (block 416). The motion of the body 203 is fed back with any motion of the frame 201 (block 418) to a second controller or relative motion controller (block 420) to generate a second control signal. The second control signal from the second controller of block 420 and the first control signal from the first controller of block 410 are combined to control the VCM in block 412 to produce the compensation force. By providing active feedback control to the VCM using the pressure difference and the relative motion measurements, this system ensures that the supported body 203 is isolated from the external vibrations and disturbances as well as ambient pressure fluctuations and vacuum regulation irregularities.

Pneumatic Suspension with Sectioned Vacuum Chambers

FIG. 8 is a simplified elevational view of a pneumatic suspension apparatus 500 with sectioned or partitioned vacuum chambers. As in the previous embodiments of FIGS. 3 and 5, the pneumatic suspension apparatus 500 also includes a frame 501 defining an upper chamber 502 in which a piston or body 509 is movably disposed. The body 509 is mechanically connected to a load 503 via a connecting member 510 such as rod or link; the body 509 and load 503 are both integral part of the supported structure (i.e., projection optical system). An air outlet 505 is provided through the frame 501, and is connected to a vacuum pump to pump air out of the upper chamber 502 to produce a vacuum in the upper chamber 502. The body 509 is spaced from the side wall of the frame 501 by a small gap. A vacuum seal 508 is provided in the gap between the body 509 and the side wall of the frame 501. The vacuum seal 508 may include a soft rubber or a diaphragm, and is desirably as thin and soft as possible to minimize vibration and disturbance transmission from the frame 501 to the load 503.

It may be desirable to prevent exposure of the material of the vacuum seal 508 to the ambient to protect the vacuum seal 508 from deterioration, attack, or the like. The pneumatic suspension apparatus 500 of FIG. 8 includes a lower vacuum chamber 504 disposed in the frame 501 connected to a vacuum source via an outlet 506. The lower vacuum chamber 504 is enclosed by the upper vacuum seal 508 and the lower vacuum seal 507. The lower vacuum seal 507 is made of a material that has a higher stiffness than the material of the upper vacuum seal 508, and that is safe to exposure to the ambient. The upper vacuum chamber 502 has a higher vacuum than the lower vacuum chamber 504.

The majority of the lift force comes from the pressure difference between the top side and the under side of the body 509. The pressure in the lower vacuum chamber is regulated through the outlet 506 to a vacuum level slightly lower than the ambient pressure level to ensure low spring effect at the lower vacuum chamber 504 while still providing enough lift force to support the weight load 503 through the body 509.

The lower seal 507 is stiffer than the upper seal 508 but introduces little additional coupling between the body 509 and the frame 501 because the lower seal 507 is allowed to cover a much larger area than the upper seal 508 (since the area of the connecting member 510 is substantially smaller than the area of the body 509). For instance, the lower seal 507 may have an area that is at least twice, more desirably at least three times, the area of the upper seal 508. The larger the area which the seal material covers, the softer (smaller) the seal stiffness is, thereby providing better isolation from vibration at the body 503. The area covered by the seal material encroaches the effective area that is used to generate the lift force. This embodiment utilizes sectioned chambers. The upper vacuum chamber 502 produces the main lift force and employs a very soft seal material for the upper seal 508 to ensure a very low seal stiffness. The lower vacuum chamber 504 employs a stiffer material for the lower seal 507 but the lower seal 507 covers a much larger area so as to achieve a very low seal stiffness. In some cases, the lower seal 507 may have a corrugated construction to increases its actual area.

The use of exposure apparatus provided herein is not limited to a photolithography system for semiconductor manufacturing. The exposure apparatus, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask to a substrate with the mask located close to the substrate without the use of a lens assembly.

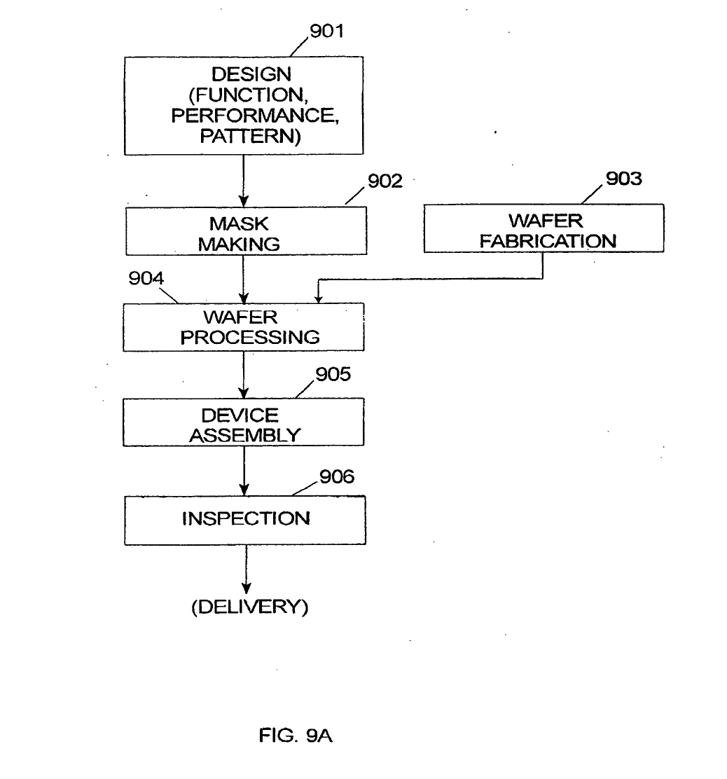

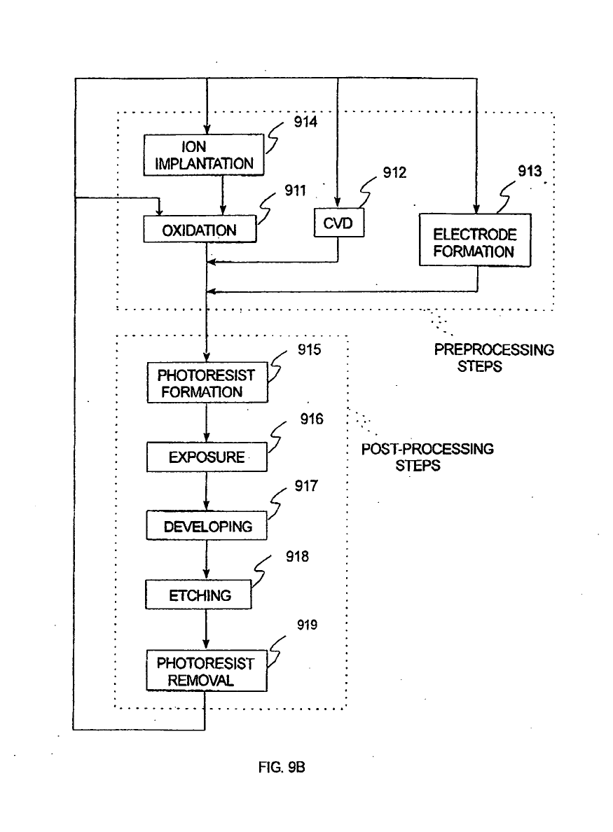

Semiconductor devices can be fabricated using the above described systems, by the process shown generally in FIG. 9A. In step 901 the device's function and performance characteristics are designed. Next, in step 902, a mask (reticle) having a pattern is designed according to the previous designing step, and in a parallel step 903 a wafer is made from a silicon material. The mask pattern designed in step 902 is exposed onto the wafer from step 903 in step 904 by a photolithography system described herein in accordance with the present invention. In step 905, the semiconductor device is assembled (including the dicing process, bonding process and packaging process), finally, the device is inspected in step 906.

FIG. 9B illustrates a detailed flowchart example of the above-mentioned step 904 in the case of fabricating semiconductor devices. In FIG. 9B, in step 911 (oxidation step), the wafer surface is oxidized. In step 912 (CVD step), an insulation film is formed on the wafer surface. In step 913 (electrode formation step), electrodes are formed on the wafer by vapor deposition. In step 914 (ion implantation step), ions are implanted in the wafer. The above mentioned steps 911-914 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 915 (photoresist formation step), photoresist is applied to a wafer. Next, in step 916 (exposure step), the above-mentioned exposure device is used to transfer the circuit pattern of a mask (reticle) to a wafer. Then in step 917 (developing step), the exposed wafer is developed, and in step 918 (etching step), parts other than residual photoresist (exposed material surface) are removed by etching. In step 919 (photoresist removal step), unnecessary photoresist remaining after etching is removed. Multiple circuit patterns are formed by repetition of these preprocessing and post-processing steps.

This invention can be utilized in an immersion type exposure apparatus with taking suitable measures for a liquid. For example, PCT Patent Application WO 99/49504 discloses an exposure apparatus in which a liquid is supplied to the space between a substrate (wafer) and a projection lens system in exposure process. As far as is permitted, the disclosures in WO 99/49504 are incorporated herein by reference.

Further, this invention can be utilized in an exposure apparatus that comprises two or more substrate and/or reticle stages. In such apparatus, the additional stage may be used in parallel or preparatory steps while the other stage is being used for exposing. Such a multiple stage exposure apparatus are described, for example, in Japanese Patent Application Disclosure No. 10-163099 as well as Japanese Patent Application Disclosure No. 10-214783 and its counterparts U.S. Pat. No. 6,341,007, No. 6,400,441, No. 6,549,269, and No. 6,590,634. Also it is described in Japanese Patent Application Disclosure No. 2000-505958 and its counterparts U.S. Pat. No. 5,696,411 as well as U.S. Pat. No. 6,208,407. As far as is permitted, the disclosure in the above-mentioned U.S. patents, as well the Japanese Patent Applications, are incorporated herein by reference.

This invention can be utilized in an exposure apparatus that has a movable stage retaining a substrate (wafer) for exposing it, and a stage having various sensors or measurement tools for measuring, as described in Japanese Patent Application Disclosure 11-135400. As far as is permitted, the disclosure in the above-mentioned Japanese Patent Application is incorporated herein by reference.

It is to be understood that the above description is intended to be illustrative and not restrictive. Many embodiments will be apparent to those of skill in the art upon reviewing the above description. For instance, suitable force compensation motors other than voice coil motors may be used. The scope of the invention should, therefore, be determined not with reference to the above description, but instead should be determined with reference to the appended claims along with their full scope of equivalents.

1. A pneumatic suspension system for a load, the pneumatic suspension system comprising:
a frame; and
a body movably disposed in the frame and spaced from a side wall of the frame by a gap to define a chamber in the frame above the body, the body being configured to be connected to the load;
wherein the frame includes an outlet to draw a gas from the chamber to lower the pressure in the chamber with respect to an ambient pressure outside the frame;
wherein an air bearing is formed in the gap between the body and the side wall of the frame to provide non-contact between the body and the frame; and
wherein the pressure in the chamber is sufficiently lower than the ambient pressure to produce a lift force to lift the body and the load connected thereto with respect to the frame.

2. The pneumatic suspension system of claim 1 wherein the gap is about 5 microns or less and is greater than zero.

3. The pneumatic suspension system of claim 1 wherein the frame includes an inlet to introduce a gas into the gap between the body and the side wall of the frame to form the air bearing.

4. The pneumatic suspension system of claim 3 wherein the frame includes a porous portion disposed on the side wall and coupled to the inlet to distribute the gas into the gap between the body and the side wall of the frame to form the air bearing.

5. The pneumatic suspension system of claim 1 wherein the body is connected to an optical system of a projection exposure apparatus.

6. The pneumatic suspension system of claim 5 comprising three frames and three corresponding bodies movably disposed in the frames, respectively, wherein the bodies are connected to a suspension frame of the optical system at three locations which are spaced apart by about 120°.

7. The pneumatic suspension system of claim 1 further comprising a force compensation motor coupled between the frame and the body.

8. An exposure apparatus provided with an optical device that is suspended by the pneumatic suspension system of claim 1,
wherein an image is formed on a substrate by the optical system.

9. A device manufactured with the exposure apparatus of claim 8.

10. A wafer on which an image has been formed by the exposure apparatus of claim 8.

11. A pneumatic suspension system for a load, the pneumatic suspension system comprising:
a frame;
a body movably disposed in the frame and spaced from a side wall of the frame by a gap to define a chamber in the frame above the body, the body being configured to be connected to the load;
a seal disposed in the gap and connected between the body and the side wall of the frame; and
a force compensation motor coupled between the frame and the body;
wherein the frame includes an outlet to draw a gas from the chamber to lower the pressure in the chamber with respect to an ambient pressure outside the frame; and
wherein the pressure in the chamber is sufficiently lower than the ambient pressure to produce a lift force to lift the body and the load connected thereto with respect to the frame.

12. The pneumatic suspension system of claim 11 wherein the seal comprises a soft rubber or a diaphragm.

13. The pneumatic suspension system of claim 11 wherein the force compensation motor is configured to produce a vertical compensation force in a direction parallel to the lift force.

14. (canceled)

15. The pneumatic suspension system of claim 11 wherein the force compensation motor comprises a voice coil motor.

16. The pneumatic suspension system of claim 11 wherein the force compensation motor is disposed inside the chamber of the frame.

17. The pneumatic suspension system of claim 11 wherein the force compensation motor is disposed outside the chamber of the frame.

18. The pneumatic suspension system of claim 11 wherein the body is connected to an optical system of a projection exposure apparatus.

19. The pneumatic suspension system of claim 18 comprising three frames and three corresponding bodies movably disposed in the frames, respectively, wherein the bodies are connected to a suspension frame of the optical system at three locations which are spaced apart by about 120°.

20. The pneumatic suspension system of claim 19 wherein the force compensation motor is configured to produce a vertical compensation force in a direction parallel to the lift force.

21. The pneumatic suspension system of claim 11 further comprising:
a first controller configured to receive a pressure difference measurement between the pressure in the chamber and the ambient pressure and to provide feedback control to the force compensation motor based on the pressure difference measurement.

22. The pneumatic suspension system of claim 21 further comprising:
a second controller configured to receive a relative motion measurement between the body and the frame and to provide feedback control to the force compensation motor based on the relative motion measurement.

23. The pneumatic suspension system of claim 21 wherein the feedback control from the first controller is configured to compensate for pressure fluctuation and irregularity.

24. The pneumatic suspension system of claim 11 further comprising:
a second controller configured to receive a relative motion measurement between the body and the frame and to provide feedback control to the force compensation motor based on the relative motion measurement.

25. The pneumatic suspension system of claim 24 wherein the feedback control from the second controller is configured to compensate for external vibration and disturbance of the seal.

26. A pneumatic suspension system for a load, the pneumatic suspension system comprising:
a frame;
a body movably disposed in the frame and spaced from a side wall of the frame by a gap to define an upper chamber in the frame above the body;
an upper seal disposed in the gap and connected between the body and the side wall of the frame;
a connecting member connected to the body and configured to be connected to the load; and
a lower seal disposed below the body and connected between the connecting member and the side wall of the frame to define a lower chamber in the frame between the upper seal and the lower seal;
wherein the frame includes an upper outlet to draw a gas from the upper chamber to lower the pressure in the upper chamber with respect to an ambient pressure outside the frame;
wherein the frame includes a lower outlet to draw a gas from the lower chamber to lower the pressure in the lower chamber with respect to the ambient pressure; and
wherein the pressure in the upper chamber is sufficiently lower than the pressure in the lower chamber to produce a lift force to lift the body and the load connected thereto with respect to the frame.

27. The pneumatic suspension system of claim 26 wherein the lower seal is made of a material which has a higher stiffness than a material of which the upper seal is made.

28. The pneumatic suspension system of claim 26 wherein the lower seal is made of a material which is safer to exposure to the ambient than a material of which the upper seal is made.

29. The pneumatic suspension system of claim 26 wherein the pressure in the lower chamber is slightly lower than the ambient pressure.

30. The pneumatic suspension system of claim 26 wherein the lower seal has a larger area than the upper seal.

31. The pneumatic suspension system of claim 30 wherein the lower seal has a substantially larger area than the upper seal.

32. The pneumatic suspension system of claim 26 wherein the lower seal has a corrugated construction.

33. The pneumatic suspension system of claim 26 wherein the body is connected to an optical system of a projection exposure apparatus.

34. The pneumatic suspension system of claim 33 comprising three frames and three corresponding bodies movably disposed in the frames, respectively, wherein the bodies are connected to a suspension frame of the optical system at three locations which are spaced apart by about 120°.

35. The pneumatic suspension system of claim 26 further comprising a force compensation motor coupled between the frame and the body.

36. The pneumatic suspension system of claim 26 wherein the force compensation motor comprises a voice coil motor.

37. The pneumatic suspension system of claim 26 wherein the force compensation motor is disposed inside the upper chamber or lower chamber of the frame.

38. The pneumatic suspension system of claim 26 wherein the force compensation motor is disposed outside the upper chamber and the lower chamber of the frame.
